(19) United States
(12) Patent Application Publication
(10) Pub. No.: US 2021/0291572 A1
(43) Pub. Date: Sep. 23, 2021

(54) SUBSTRATE CARTRIDGE

(71) Applicant: SEIKO EPSON CORPORATION, Tokyo (JP)

(72) Inventors: Taishi SASAKI, Matsumoto-shi (JP); Akio ISHIMOTO, Shiojiri-shi (JP)

(73) Assignee: SEIKO EPSON CORPORATION, Tokyo (JP)

(21) Appl. No.: 17/205,609

(22) Filed: Mar. 18, 2021

(30) Foreign Application Priority Data
Mar. 19, 2020 (JP) 2020-048809

(51) Int. Cl. B41J 32/00; B41J 3/407; B41J 15/04

(52) U.S. Cl. CPC B41J 32/00; B41J 15/044; B41J 3/4075

(57) ABSTRACT

A substrate cartridge is attachable, with a ribbon cartridge having an ink ri()bbon, to a cartridge attachment portion of a tape printer for performing printing on a tape and is formed as a separate component from the ribbon cartridge. The substrate cartridge includes: a circuit substrate that stores tape information about one type of tape among multiple types of tape; and a substrate holder holding the circuit substrate.

The present application is based on, and claims priority from JP Application Serial Number 2020-048809, filed Mar. 19, 2020, the disclosure of which is hereby incorporated by reference herein in its entirety.

### BACKGROUND

### 1. Technical Field

The present disclosure relates to a substrate cartridge to be attached to a cartridge attachment portion of a tape printer.

### 2. Related Art

JP-A-2017-177709 discloses a printing device having a ribbon-cassette attachment portion, to which a ribbon cassette is attached. The printing device performs printing on a tube introduced in the ribbon-cassette attachment portion.

In a state in which a ribbon cassette integrated with a circuit substrate that stores tube information about, for example, a tube A, which is one type of tubes, is attached to a ribbon-cassette attachment portion, the printing device reads the tube information about the tube A from the circuit substrate. Hence, a tube other than the tube A cannot be used. In order to use a tube other than the tube A, a user needs to change the ribbon cassette attached to the ribbon-cassette attachment portion for another ribbon cassette. Thus, it has been impossible to use the ribbon cassette attached to the ribbon-cassette attachment portion with multiple types of tubes.

### SUMMARY

According to an aspect of the present disclosure, a substrate cartridge is attachable, with a ribbon cartridge having an ink ribbon, to a cartridge attachment portion of a tape printer for performing printing on a tape and is formed as a separate component from the ribbon cartridge. The substrate cartridge includes: a circuit substrate that stores tape information about one type of tape among multiple types of tape; and a substrate holder holding the circuit substrate.

### BRIEF DESCRIPTION OF THE DRAWINGS

FIG. 1 shows a tape printer without a ribbon cartridge or a substrate cartridge, as viewed from the +Z side.

FIG. 2 shows the tape printer with the ribbon cartridge and the substrate cartridge, as viewed from the +Z side.

FIG. 3 is a perspective view of the ribbon cartridge.

FIG. 4 is a perspective view of the substrate cartridge.

FIG. 5 shows the substrate cartridge, as viewed from the −Z side.

FIG. 6 is a block diagram showing the control structure of the tape printer.

FIG. 7 is a table showing tape information stored in the circuit substrate of the substrate cartridge.

FIG. 8 shows a substrate cartridge according to a modification, as viewed from the −Z side.

### DESCRIPTION OF EXEMPLARY EMBODIMENTS

Referring to the attached drawings, a substrate cartridge 201, which is an embodiment of a substrate cartridge, will be described. Although the disclosure will be described using the directions defined by the XYZ rectangular coordinate system in the drawings, the directions are used for ease of explanation and will not limit the embodiments described below.

Outline of Tape printer, Ribbon Cartridge, and Substrate Cartridge

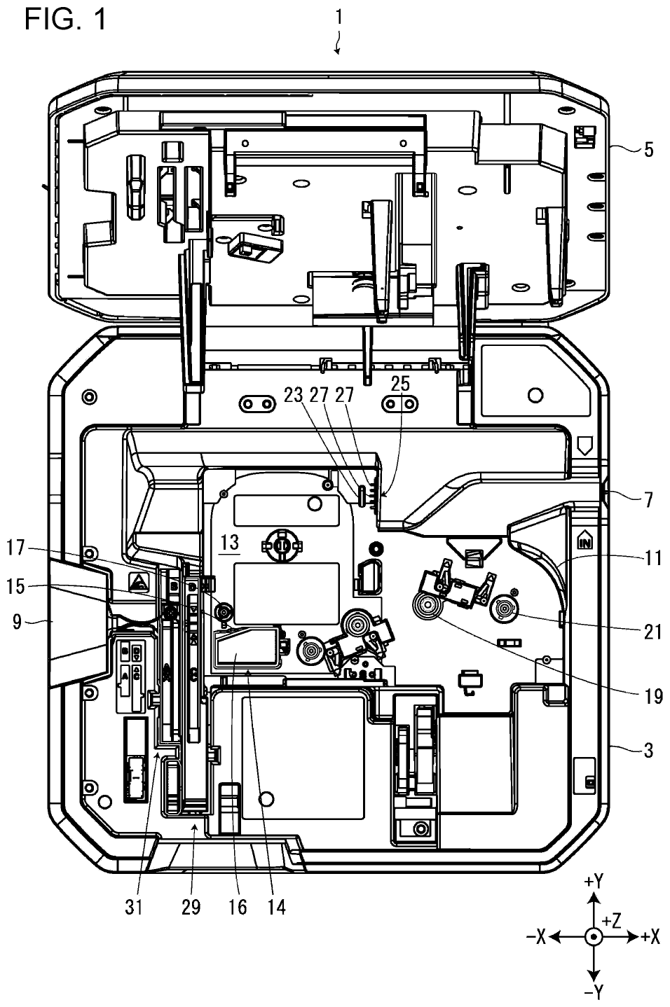

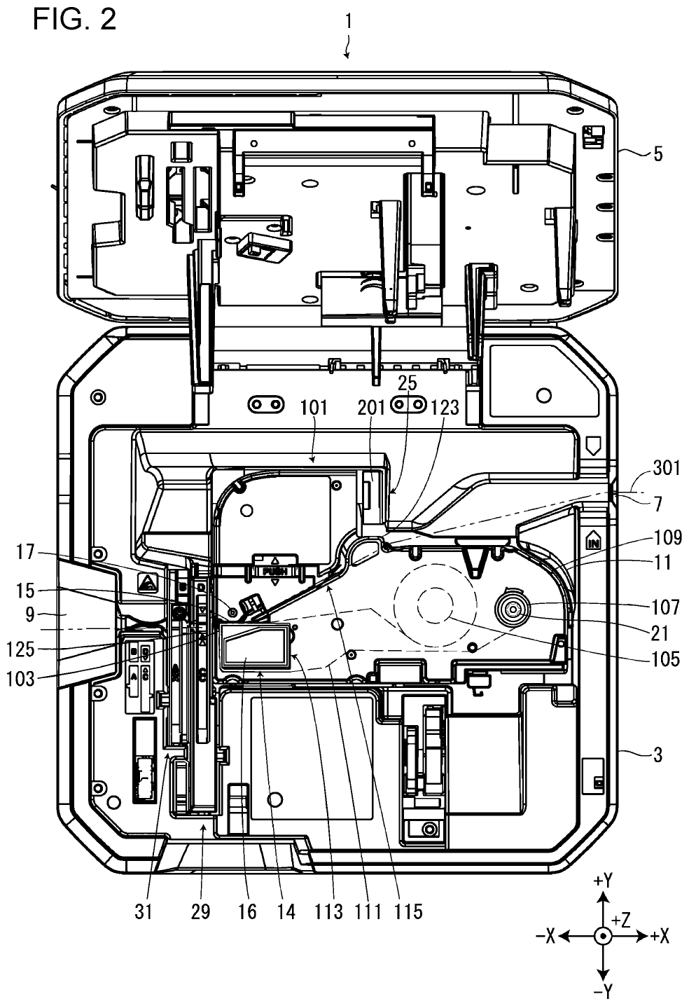

As shown in FIGS. 1 and 2, a tape printer 1 includes a printer case 3 and an attachment-portion cover 5. The printer case 3 is formed in a substantially rectangular parallelepiped shape. The printer case 3 has a printer-side tape-introduction port 7 in the +X side surface thereof and a printer-side tape-discharge port 9 in the −X side surface thereof. A tape 301 paid out of a tape roller (not shown) provided outside the tape printer 1 is introduced into the printer case 3. Specifically, the tape 301 paid out of the tape roller is introduced into the printer case 3 from the printer-side tape-introduction port 7 and is discharged outside the printer case 3 from the printer-side tape-discharge port 9. Although omitted from the illustration, the tape 301 includes a printing tape on which a thermal head 15 performs printing, and a peel-off tape removably adhered to the adhesive of the printing tape.

The attachment-portion cover 5 is pivotably attached to the +Y side end of the printer case 3 and opens and closes the cartridge attachment portion 11. A ribbon cartridge 101 and the substrate cartridge 201 are removably attached to the cartridge attachment portion 11. The cartridge attachment portion 11 is a recess with the +Z side open. A head portion 14 is provided on an attachment bottom surface 13, which is the bottom surface of the cartridge attachment portion 11. The head portion 14 includes the thermal head 15 and a head cover 16. The thermal head 15 includes a heat-generating element (not shown). The head cover 16 covers a portion of the thermal head 15. A platen shaft 17, a pay-out shaft 19, and a winding shaft 21 are provided on the attachment bottom surface 13.

The head cover 16 and the platen shaft 17 project toward the +Z side by greater amounts than the pay-out shaft 19 and the winding shaft 21. When the ribbon cartridge 101 is attached to the cartridge attachment portion 11, the head cover 16 and the platen shaft 17 pass through a head insertion hole 113 and a platen roller 103 (described below), thereby guiding the attachment of the ribbon cartridge 101.

Furthermore, an engagement projection 23 projects toward the +Z side from the attachment bottom surface 13. The substrate cartridge 201 is to be removably attached to the engagement projection 23. The engagement projection 23 is a plate-shaped member facing the inner surface of the cartridge attachment portion 11, which is located to the +X side of the engagement projection 23. Specifically, the engagement projection 23 is formed in a substantially rectangular shape elongated in the Y axis, as viewed from the +Z side.

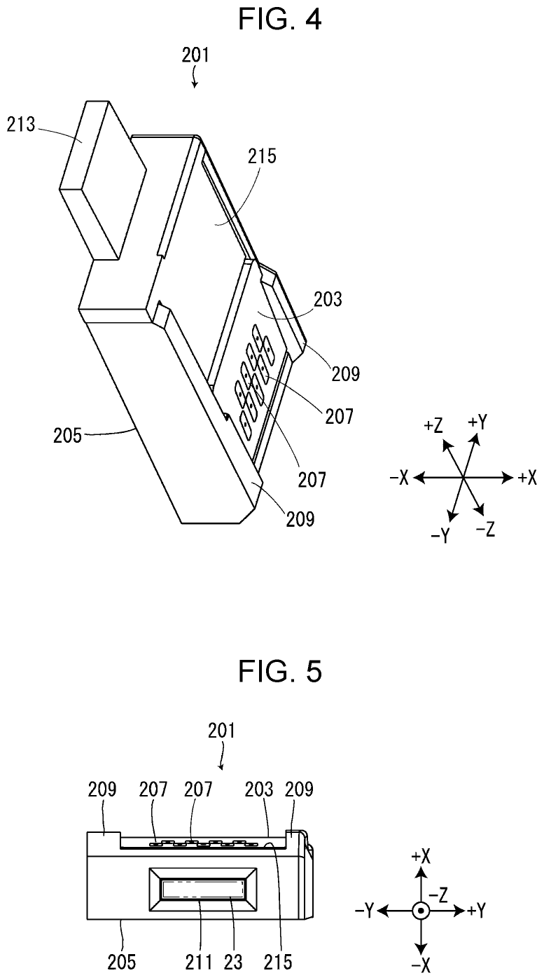

A substrate connecting portion 25 is provided on the inner surface of the cartridge attachment portion 11 facing the engagement projection 23. The substrate connecting portion 25 has a plurality of contact terminals 27. The contact terminals 27 come into contact with a plurality of electrodes 207 (see FIG. 4) provided on a circuit substrate 203 of the substrate cartridge 201. The contact terminals 27 are substantially U-shaped metal elastic members. When the substrate cartridge 201 is attached to the cartridge attachment portion 11, the contact terminals 27 are urged by the substrate cartridge 201 and are elastically deformed toward the +X side. As a result, the contact terminals 27 press the circuit substrate 203 toward the −X side with the pressing force produced by the elastic deformation thereof.

A full cutter 29 and a half cutter 31 are provided between the cartridge attachment portion 11 and the printer-side tape-discharge port 9. The full cutter 29 performs full cutting, which means cutting both the printing tape and the peel-off tape, which constitute the tape 301. The half cutter 31 performs half cutting, which means cutting one of the printing tape and the peel-off tape, which constitute the tape 301, without cutting the other, and, in this embodiment, it means cutting the printing tape without cutting the peel-off tape.

As shown in FIG. 2, the ribbon cartridge 101 includes the platen roller 103, a pay-out core 105, a winding core 107, and a cartridge case 109 accommodating the aforementioned components. An ink ribbon 111 is wound around the pay-out core 105. The ink ribbon 111 paid out of the pay-out core 105 is to be wound on the winding core 107. In the tape printer 1, the ink ribbon 111 can be rewound on the pay-out core 105 by rotating the pay-out shaft 19. The cartridge case 109 has a head insertion hole 113 penetrating in the Z axis. When the ribbon cartridge 101 is attached to the cartridge attachment portion 11, the head portion 14, the platen shaft 17, the pay-out shaft 19, and the winding shaft 21 are inserted into the head insertion hole 113, the platen roller 103, the pay-out core 105, and the winding core 107, respectively.

The cartridge case 109 has a groove-shaped tape path 115, which is open on the +Z side. The tape path 115 extends at an angle with respect to the X axis. The +X side end of the tape path 115 is called a cartridge-side tape-introduction port 123, and the −X side end of the tape path 115 is called a cartridge-side tape-discharge port 125. The tape 301 introduced into the printer case 3 from the printer-side tape-introduction port 7 is introduced into the tape path 115 from the cartridge-side tape-introduction port 123. The tape 301 introduced into the tape path 115 is discharged from the cartridge-side tape-discharge port 125 to the printer-side tape-discharge port 9. The tape path 115 extends between the head insertion hole 113 and the platen roller 103.

Before the ribbon cartridge 101 is attached to the cartridge attachment portion 11, the tape 301 is inserted by a user into the tape path 115 from one edge of the tape 301 in the width direction, i.e., the −Z side edge, toward the −Z side. The ribbon cartridge 101, with the tape 301 being inserted into the tape path 115, is attached to the cartridge attachment portion 11.

The substrate cartridge 201 is attached to the cartridge attachment portion 11, together with the ribbon cartridge 101. At this time, the substrate cartridge 201 is engaged with the engagement projection 23 projecting from the attachment bottom surface 13. In a state in which the ribbon cartridge 101 and the substrate cartridge 201 are attached to the cartridge attachment portion 11, there is a gap between the ribbon cartridge 101 and the substrate cartridge 201.

The substrate cartridge 201 and the ribbon cartridge 101 are formed as separate members. Hence, a user, after attaching the ribbon cartridge 101 and the substrate cartridge 201 to the cartridge attachment portion 11, can change only the substrate cartridge 201 for another substrate cartridge 201, without needing to remove the ribbon cartridge 101. Conversely, a user, after attaching the ribbon cartridge 101 and the substrate cartridge 201 to the cartridge attachment portion 11, can change only the ribbon cartridge 101 for another ribbon cartridge 101, without needing to remove the substrate cartridge 201.

When the attachment-portion cover 5 is closed after the ribbon cartridge 101 and the substrate cartridge 201 are attached to the cartridge attachment portion 11, a head moving mechanism (not shown) moves the thermal head 15 toward the platen shaft 17. As a result, the tape 301 and the ink ribbon 111 are nipped between the thermal head 15 and the platen roller 103. In this state, the tape printer 1 performs printing according to the print data generated by inputting text etc., into the tape printer 1 or the print data the tape printer 1 received from an external device, such as a personal computer. More specifically, the tape printer 1 prints a print image on the tape 301 and with the heated thermal head 15 according to the print data, while advancing the tape 301 and the ink ribbon 111 with the platen roller 103.

### Cartridge Case

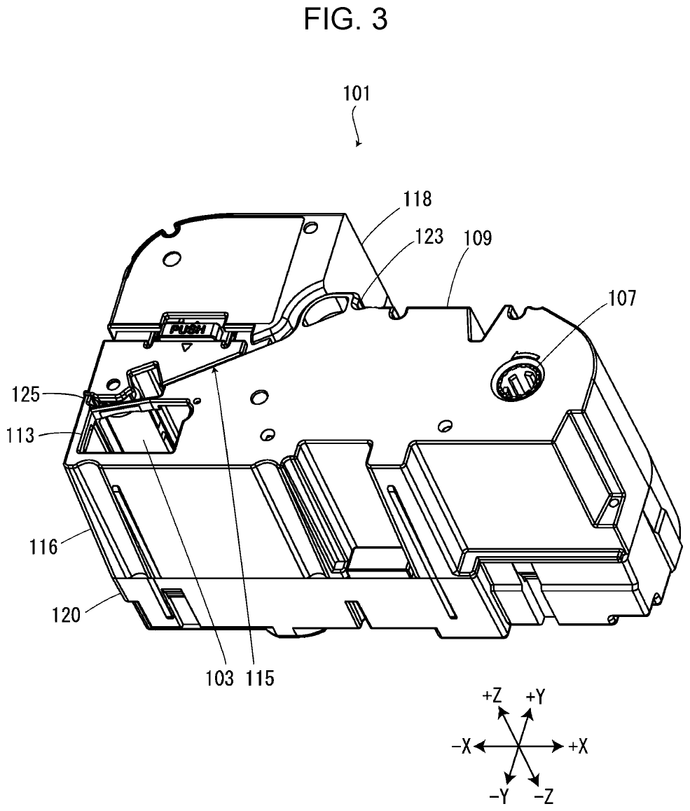

As shown in FIG. 3, the cartridge case 109 includes a first top side case 116, a second top side case 118, and a bottom side case 120. When the ribbon cartridge 101 is attached to the cartridge attachment portion 11, the first top side case 116 and the second top side case 118 are located on the opposite side in the attachment direction of the ribbon cartridge 101, and the bottom side case 120 is located in the attachment direction of the ribbon cartridge 101. The attachment direction of the ribbon cartridge 101 is a direction in which the ribbon cartridge 101 is attached to the cartridge attachment portion 11, that is, the −Z direction, and the is parallel to the axis in which the platen shaft 17 extends. The opposite side in the attachment direction of the ribbon cartridge 101 is the +Z side.

The first top side case 116 is combined with the bottom side case 120. Similarly, the second top side case 118 is combined with the bottom side case 120. The tape path 115 is provided between the first top side case 116 and the second top side case 118. In other words, the first top side case 116 is provided to the −Y side of the tape path 115, and the second top side case 118 is provided to the +Y side of the tape path 115.

### Substrate Cartridge

As shown in FIGS. 4 and 5, the substrate cartridge 201 includes the circuit substrate 203 and a substrate holder 205.

The circuit substrate 203 is formed in a substantially rectangular plate shape. The circuit substrate 203 is provided with a memory device, such as an integrated circuit (IC) package or an IC chip (not shown). A plurality of electrodes 207 are provided on the +X side surface, which is an external surface, of the circuit substrate 203. When the substrate cartridge 201 is attached to the cartridge attachment portion 11, the electrodes 207 come into contact with the contact terminals 27. As a result, the tape printer 1 can read various information stored in the memory devices and can also write various information into the memory device.

The substrate holder 205 holds the circuit substrate 203. The substrate holder 205 includes substrate holding portions 209, an engagement hole 211, and a knob 213.

The substrate holding portions 209 are provided on the −Z side of a substrate holding surface 215, which is the +X side surface of the substrate holder 205, at two positions, namely, the +Y side end and the −Y side end. Each substrate holding portion 209 projects from the substrate holding surface 215 toward the +X side and is bent toward the other substrate holding portion 209. The substrate holding portions 209 hold the circuit substrate 203, inserted into the space between the substrate holding portions 209 and the substrate holding surface 215 from the +Z side toward the −Z side, by being engaged with the +Y side edge of the circuit substrate 203 or the −Y side edge of the circuit substrate 203.

The engagement hole 211 is provided in the −Z side surface of the substrate holder 205. The engagement hole 211 has a substantially rectangular shape elongated in the Yaxis, as viewed from the −Z side. The engagement hole 211 receives the engagement projection 23 when the substrate cartridge 201 is attached to the cartridge attachment portion 11. In other words, a user can appropriately attach the substrate cartridge 201 to the cartridge attachment portion 11 by inserting the engagement projection 23 into the engagement hole 211. The edges of the engagement hole 211 are chamfered so that the engagement projection 23 can be easily inserted into the engagement hole 211.

In a state in which the engagement hole 211 is engaged with the engagement projection 23, the contact terminals 27, the circuit substrate 203, and the engagement projection 23 are arranged in this order from the +X side. Hence, the engagement projection 23 receives a pressing force toward the −X side, exerted by the contact terminals 27. As a result, deflection of the circuit substrate 203 subjected to the pressing force from the contact terminals 27 is suppressed.

The knob 213 projects from the +Z side surface of the substrate holder 205 toward the +Z side. The knob 213 is held by a user when the substrate cartridge 201 is attached to the cartridge attachment portion 11 or when the substrate cartridge 201 is removed from the cartridge attachment portion 11. In other words, a user can easily attach the substrate cartridge 201 to the cartridge attachment portion 11 and can easily remove the substrate cartridge 201 from the cartridge attachment portion 11 by holding the knob 213 with fingers.

### Controller

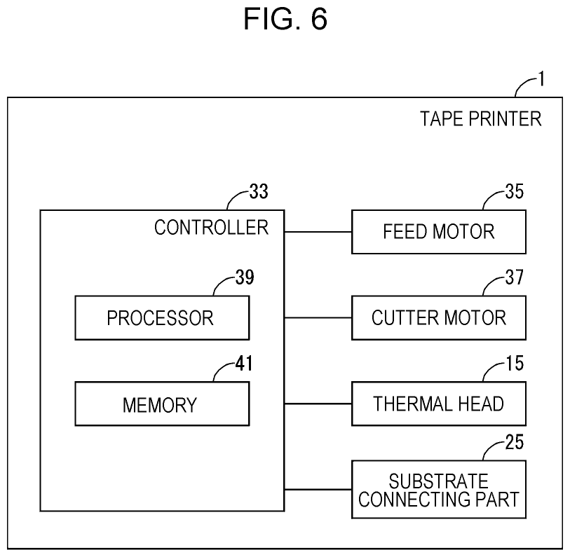

As shown in FIG. 6, the tape printer 1 includes a controller 33. The controller 33 controls a feed motor 35, a cutter motor 37, and the thermal head 15. The feed motor 35 is the driving source of the platen roller 103. The cutter motor 37 is the driving source of the full cutter 29 and the half cutter 31. The controller 33 reads, via the substrate connecting portion 25, various information from the circuit substrate 203 of the substrate cartridge 201 attached to the cartridge attachment portion 11 and writes various information in the circuit substrate 203.

The controller 33 includes a processor 39 and a memory 41. The processor 39 performs various control processing by executing programs stored in the memory 41. The processor 39 is, for example, one or more central processing units (CPU). The processor 39 may also be a hardware circuit, such as an application specific integrated circuit (ASIC), or may be configured such that at least one CPU and a hardware circuit, such as ASIC, work together to perform processing. The memory 41 includes, for example, a read-only memory (ROM), a random-access memory (RAM), and a character generator ROM (CGROM).

### Information Stored in Circuit Substrate

There are multiple types of tape 301, which differ in width, material, etc. The circuit substrate 203 stores the tape information about one type of tape 301 among the plurality of types of tape 301. For example, when there are three types of tape 301, namely, a tape A, a tape B, and a tape C, the substrate cartridge 201 having the circuit substrate 203 that stores the tape information about the tape A is called a substrate cartridge A, the substrate cartridge 201 having the circuit substrate 203 that stores the tape information about the tape B is called a substrate cartridge B, and the substrate cartridge 201 having the circuit substrate 203 that stores the tape information about the tape C is called a substrate cartridge C.

The substrate cartridge 201 is sold with a tape 301 corresponding to the tape information stored in the circuit substrate 203. For example, the substrate cartridge A is sold with the tape A. In other words, the circuit substrate 203 of the substrate cartridge 201 stores the tape information about the tape 301 to be sold with that substrate cartridge 201. Note that the substrate cartridge 201 and the tape 301 may be sold separately.

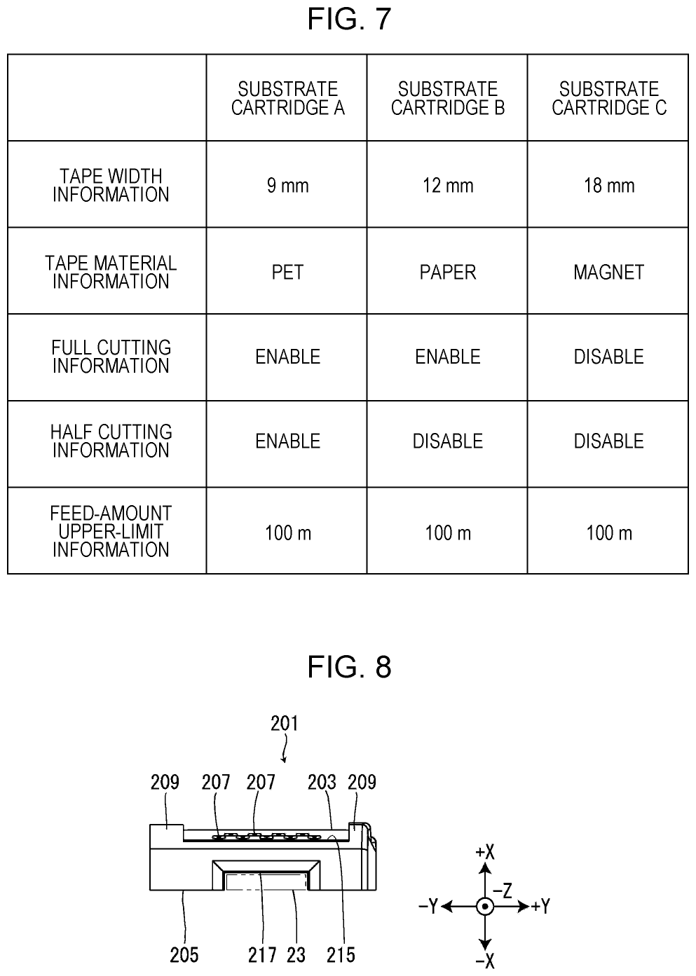

As shown in FIG. 7, the tape information stored in the circuit substrate 203 of the substrate cartridge 201 includes tape width information, tape material information, full cutting information, half cutting information, and feed-amount upper-limit information.

The tape width information is information about the width of the tape 301. The widths of the tape 301 include, for example, 9 mm, 12 mm, 18 mm, 24 mm, 36 mm, and 50 mm.

The tape material information is information about the material of the tape 301. The materials of the tape 301 include, for example, polyethylene terephthalate (PET), polyvinyl chloride (PVC), cloth, paper, and magnet.

The full cutting information is information about whether full cutting by the full cutter 29 is disabled or not. The full cutting information is set to, for example, either disable or enable, depending on the material of the tape 301. The controller 33 controls the cutter motor 37 according to the full cutting information read from the circuit substrate 203. Specifically, when the full cutting information is set to disable, the controller 33 inhibits the cutter motor 37 from operating to perform full cutting, whereas, when the full cutting information is set to enable, the controller 33 allows the cutter motor 37 to operate so that the tape 301 is fully cut at a predetermined position.

The half cutting information is information about whether half cutting by the half cutter 31 is disabled or not. The half cutting information is set to, for example, either disable or enable, depending on the material of the tape 301. The controller 33 controls the cutter motor 37 according to the half cutting information read from the circuit substrate 203. Specifically, when the half cutting information is set to disable, the controller 33 inhibits the cutter motor 37 from operating to perform half cutting, whereas, when the half cutting information is set to enable, the controller 33 allows the cutter motor 37 to operate so that the tape 301 is half-cut at a predetermined position.

The feed-amount upper-limit information is information about the feed-amount upper limit value. The feed-amount upper limit value means the upper limit value of the amount by which the tape printer 1 feeds the tape 301. Specifically, when the amount of feed of the tape 301 reaches the feed upper limit value indicated by the feed-amount upper-limit information, read from the circuit substrate 203, the controller 33 controls the feed motor 35 so as not to feed the tape 301 anymore. When, for example, the feed motor 35 is a stepping motor, the controller 33 obtains the amount of feed of the tape 301 on the basis of the number of pulses applied to the feed motor 35.

The feed-amount upper limit value is set to a value at least twice the length of the tape 301. In this embodiment, the length of the tape 301 is, for example, 45 m, and the feed-amount upper limit value is set to a value at least twice that length, that is, for example, 100 m.

For example, as shown in FIG. 7, the circuit substrate 203 of the substrate cartridge A stores the tape information about the tape A as follows: the tape width information: 9 mm, the tape material information: PET, the full cutting information: enable, the half cutting information: enable, and the feed-amount upper-limit information: 100 m.

The tape printer 1 performs various control processing on the basis of the various information read from the circuit substrate 203. As a result, the tape printer 1 can perform various control processing according to the type of the tape 301, without requiring a user to perform various setting operations, such as ON/OFF of full cutting, according to the type of the tape 301.

Because the circuit substrate 203 stores the information about the tape 301, if, unlike the configuration in this embodiment, the circuit substrate 203 and the ribbon cartridge 101 are integrated, that is, for example, in a state in which the ribbon cartridge 101 integrated with the circuit substrate 203 that stores the information about the tape A is attached to the cartridge attachment portion 11, a tape 301 other than the tape A cannot be used. More specifically, in a state in which the ribbon cartridge 101 integrated with the circuit substrate 203 that stores the information about the tape A is attached to the cartridge attachment portion 11, the tape printer 1 reads the information about the tape A from the circuit substrate 203 and performs various control processing suitable for the tape A. However, this control processing is not necessarily suitable for a tape 301 other than the tape A.

Hence, when using a tape 301 other than the tape A, a user needs to change the ribbon cartridge 101 attached to the cartridge attachment portion 11 for another ribbon cartridge 101. For example, when changing a tape A for a tape B, a user needs to remove the ribbon cartridge 101 integrated with the circuit substrate 203 that stores the information about the tape A from the cartridge attachment portion 11 and attach the ribbon cartridge 101 integrated with the circuit substrate 203 that stores the information about the tape B to the cartridge attachment portion 11. Hence, the ribbon cartridge 101 attached to the cartridge attachment portion 11 cannot be used with multiple types of tape 301.

In contrast, in this embodiment, the substrate cartridge 201 and the ribbon cartridge 101 are formed as separate components. In other words, the circuit substrate 203 and the ribbon cartridge 101 are formed as separate components. Hence, when changing a tape 301 for another type of tape 301, a user only needs to change the substrate cartridge 201 attached to the cartridge attachment portion 11 for a substrate cartridge 201 having the circuit substrate 203 that stores the tape information about the tape 301 to be attached after changing. For example, when a user, in a state in which the ribbon cartridge 101 and the substrate cartridge A are attached to the cartridge attachment portion 11, intends to change the tape A for the tape B, the user only needs to remove the substrate cartridge A from the cartridge attachment portion 11 and attach the substrate cartridge B to the cartridge attachment portion 11, without removing the ribbon cartridge 101 from the cartridge attachment portion 11. By doing so, after the substrate cartridge 201 is changed, the tape printer 1 reads the information about the tape B from the circuit substrate 203 and performs various control processing suitable for the tape B. Hence, the ribbon cartridge 101 attached to the cartridge attachment portion 11 can be used with multiple types of tape 301.

Furthermore, because the feed-amount upper limit value is set to a value at least twice the length of the tape 301, even when printing is performed on two tapes 301, the amount of feed of the tape 301 does not reach the feed-amount upper limit value. Accordingly, printing can be performed on two or more tapes 301 without changing the substrate cartridge 201 attached to the cartridge attachment portion 11 for another substrate cartridge 201. Although the length of the ink ribbon 111 accommodated in the ribbon cartridge 101 is not specifically limited, the length is, for example, substantially the same as the length of the tape 301. In this case, the feed-amount upper limit value is set to a value at least twice the length of the ink ribbon 111. Hence, even when printing is performed using two ribbon cartridges 101, the amount of feed of the tape 301 does not reach the feed-amount upper limit value. Accordingly, printing can be performed using two or more ribbon cartridges 101 without changing the substrate cartridge 201 attached to the cartridge attachment portion 11 for another substrate cartridge 201.

### OTHER MODIFICATIONS

It is of course to be understood that the present disclosure is not limited to the above-described embodiments and that various configurations can be employed without departing from the sprit thereof. For example, the above-described embodiments can be modified in the forms below. The embodiments and the modifications may be combined.

As shown in FIG. 8, the substrate holder 205 of the substrate cartridge 201 may have an engaging recess 217, instead of the engagement hole 211. The engaging recess 217 has a substantially C shape with the −X side open, when viewed from the −Z side. The engaging recess 217 is engaged with the engagement projection 23 such that the engagement projection 23 enters the engaging recess 217 when the substrate cartridge 201 is attached to the cartridge attachment portion 11. In other words, a user can appropriately attach the substrate cartridge 201 to the cartridge attachment portion 11 by engaging the engagement projection 23 with the engaging recess 217. The edges of the engaging recess 217 are chamfered, similarly to the edges of the engagement hole 211, so that the engaging recess 217 and the engagement projection 23 are easily engaged.

Furthermore, in a state in which the engaging recess 217 is engaged with the engagement projection 23, similarly to the state in which the engagement hole 211 is engaged with the engagement projection 23, the contact terminals 27, the circuit substrate 203, and the engagement projection 23 are arranged in this order from the +X side. Hence, the engagement projection 23 receives a pressing force toward the −X side, exerted by the contact terminals 27. As a result, deflection of the circuit substrate 203 subjected to the pressing force from the contact terminals 27 is suppressed.

In the above-described embodiment, it has been described that a user can independently attach the ribbon cartridge 101 and the substrate cartridge 201 to the cartridge attachment portion 11. However, the present disclosure is not limited to such a configuration. The ribbon cartridge 101 and the substrate cartridge 201 may be configured such that the substrate cartridge 201 can be attached to the ribbon cartridge 101. More specifically, a configuration is possible in which a user attaches the ribbon cartridge 101 to the cartridge attachment portion 11 after attaching the substrate cartridge 201 to the ribbon cartridge 101. The engagement hole 211 may be provided in the ribbon cartridge 101, instead of the substrate cartridge 201.

### Additional Explanation

An additional explanation about the substrate cartridge will be given below.

The substrate cartridge is attachable, with a ribbon cartridge having an ink ribbon, to a cartridge attachment portion of a tape printer for performing printing on a tape and is formed as a separate component from the ribbon cartridge. The substrate cartridge includes: a circuit substrate that stores tape information about one type of tape among multiple types of tape; and a substrate holder holding the circuit substrate.

In this configuration, the circuit substrate and the ribbon cartridge are formed as separate components. Hence, when changing a tape for another type of tape, a user only needs to change the substrate cartridge attached to the cartridge attachment portion for a substrate cartridge having a circuit substrate that stores the tape information about the tape to be attached after changing, without changing the ribbon cartridge attached to the cartridge attachment portion for another ribbon cartridge. Accordingly, the ribbon cartridge attached to the cartridge attachment portion can be used with multiple types of tape.

In this case, the cartridge attachment portion may have an engagement projection, and the substrate holder may have an engagement portion that engages with the engagement projection when the substrate cartridge is attached to the cartridge attachment portion.

With this configuration, a user can appropriately attach the substrate cartridge to the cartridge attachment portion by engaging the engagement portion with the engagement projection.

The engagement hole 211 is an example of the engagement portion. The engaging recess 217 is an example of the engagement portion.

In this case, the engagement portion may be an engagement hole that receives the engagement projection when the substrate cartridge is attached to the cartridge attachment portion.

With this configuration, a user can appropriately attach the substrate cartridge to the cartridge attachment portion by inserting the engagement projection into the engagement hole.

In this case, the circuit substrate may store a feed-amount upper limit value, which is an upper limit value of an amount by which the tape is to be fed, as the tape information, and the feed-amount upper limit value may be a value at least twice the length of the tape.

With this configuration, it is possible to perform printing on two or more tapes without changing the substrate cartridge attached to the cartridge attachment portion for another substrate cartridge.

What is claimed is:

1. A substrate cartridge that is attachable, with a ribbon cartridge having an ink ribbon, to a cartridge attachment portion of a tape printer for performing printing on a tape and that is formed as a separate component from the ribbon cartridge, the substrate cartridge comprising:
a circuit substrate that stores tape information about one type of tape among multiple types of tape; and
a substrate holder holding the circuit substrate.

2. The substrate cartridge according to claim 1, wherein
the cartridge attachment portion has an engagement projection, and
the substrate holder has an engagement portion that engages with the engagement projection when the substrate cartridge is attached to the cartridge attachment portion.

3. The substrate cartridge according to claim 2, wherein the engagement portion is an engagement hole that receives the engagement projection when the substrate cartridge is attached to the cartridge attachment portion.

4. The substrate cartridge according to claim 1, wherein
the circuit substrate stores a feed-amount upper limit value, which is an upper limit value of an amount by which the tape is to be fed, as the tape information, and
the feed-amount upper limit value is a value at least twice a length of the tape.
